(19) United States
(12) Patent Application Publication
(10) Pub. No.: US 2022/0311331 A1
(43) Pub. Date: Sep. 29, 2022

(54) ADAPTIVE ENERGY STORAGE CIRCUIT

(71) Applicant: Monolithic Power Systems, Inc., San Jose, CA (US)

(72) Inventor: Yancun Li, San Jose, CA (US)

(21) Appl. No.: 17/215,100

(22) Filed: Mar. 29, 2021

(51) Int. Cl. H02M 1/44; H02M 3/24

(52) U.S. Cl. CPC H02M 1/44; H02M 3/24

(57) ABSTRACT

An energy storage circuit configured to filter a rectified voltage provided on an input bus, and to provide an input voltage on the input bus, having: a first capacitor, coupled between the input bus and a ground potential; a second capacitor; and a second capacitor control switch, coupled in series with the second capacitor, wherein the second capacitor and second capacitor control switch are coupled between the input bus and the ground potential; wherein the second capacitor control switch is turned on when an input voltage provided by the input bus is lower than a reference voltage to couple the second capacitor in parallel with the first capacitor.

The present invention relates generally to electronic circuits, and more particularly but not exclusively to circuits that utilize capacitors for storing energy in a power supply converter.

### BACKGROUND

Prior art AC-DC power converters typically have three parts that performing distinct functions: input rectification, voltage reservoir and DC-DC conversion. Commonly, a bulky electrolytic capacitor (E-CAP) is configured to perform the voltage reservoir function. The E-CAP is very large and usually occupy around 30% to 40% total space/volume of the AC-DC power converter, which remarkably harms the power density. Nowadays, a variety of solutions (commonly increasing switching frequency of the AC-DC power converter or adding soft-switching functions to the AC-DC power converter) are used to improve the power density in a power converter. However, the E-CAP is still a big obstacle in power converter size reduction and limits the power density.

### SUMMARY

It is an object of the present invention to shrink the E-CAP size in a cost effective way to improve the power density of the power converter.

In accomplishing the above and other objects, there has been provided, in accordance with an embodiment of the present invention, an energy storage circuit configured to filter a rectified voltage provided on an input bus, and to provide an input voltage on the input bus, the energy storage circuit comprising: a first capacitor, coupled between the input bus and a ground potential; a second capacitor; and a second capacitor control switch, coupled in series with the second capacitor between the input bus and the ground potential; wherein the second capacitor control switch is turned on when the input voltage is lower than a lower limit to couple the second capacitor in parallel with the first capacitor, and the second capacitor control switch is turned off when the input voltage is higher than an upper limit to disconnect the second capacitor from the first capacitor.

In accomplishing the above and other objects, there has been provided, in accordance with an embodiment of the present invention, an energy storage circuit configured to filter a rectified voltage provided on an input bus, and to provide an input voltage on the input bus, comprising: a first capacitor, coupled between the input bus and a ground potential; a second capacitor; and a second capacitor control switch, coupled in series with the second capacitor between the input bus and the ground potential; wherein the second capacitor control switch is turned on when the input voltage is lower than a reference voltage to couple the second capacitor in parallel with the first capacitor.

In accomplishing the above and other objects, there has been provided, in accordance with an embodiment of the present invention, a power converter, comprising: a first capacitor, coupled between an input bus and a ground potential, wherein the first capacitor is configured to filter a rectified voltage to produce an input voltage on the input bus; a second capacitor; a second capacitor control switch, coupled in series with the second capacitor between the input bus and the ground potential, wherein the second capacitor is coupled in parallel with the first capacitor when the input voltage is lower than a lower limit; and a DC-DC power converter, configured to convert the input voltage to a required voltage level.

### BRIEF DESCRIPTION OF THE DRAWINGS

FIG. 1 schematically shows a prior art AC-DC power converter 10.

FIG. 2 schematically shows an AC-DC power converter 20 in accordance with an embodiment of the present invention.

FIG. 3 schematically shows a control circuit 30 in accordance with an embodiment of the present invention.

FIG. 4 schematically shows an AC-DC power converter 40 in accordance with an embodiment of the present invention.

FIG. 5 schematically shows a control circuit 50 in accordance with an embodiment of the present invention.

The use of the same reference label in different drawings indicates the same or like components.

### DETAILED DESCRIPTION

In the present invention, numerous specific details are provided, such as examples of circuits, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

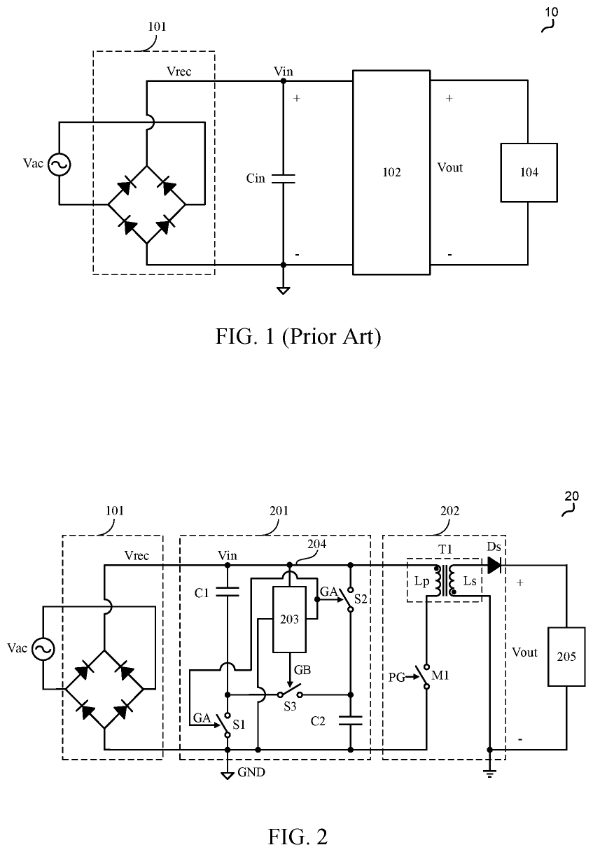

FIG. 1 schematically shows a prior art AC-DC power converter 10. As shown in FIG. 1, the AC-DC power converter 10 comprises a rectifier 101, an E-CAP Cin and a DC-DC converter 102. The rectifier 101 is configured to convert an AC line voltage Vac to a rectified voltage Vrec. The E-CAP Cin is configured to filter the rectified voltage Vrec, and to provide a relatively smooth input voltage Vin to the DC-DC converter 102. The DC-DC converter 102 is configured to convert the input voltage Vin to a required voltage level to power a load 104.

In the prior art AC-DC power converter 10, a capacitance of the E-CAP Cin is determined by a lowest rectified voltage and a highest output power consumed by the load 104, which significantly lower its utilization in high rectified voltage.

FIG. 2 schematically shows an AC-DC power converter 20 in accordance with an embodiment of the present invention. The AC-DC power converter 20 comprises a rectifier 101, an energy storage circuit 201 and a DC-DC converter 202. As shown in FIG. 2, the energy storage circuit 201 functions as an E-CAP to filter the rectified voltage Vrec on an input bus 204 and then to provide the smoothed input voltage Vin on the input bus 204. The energy storage circuit 201 comprises a first capacitor C1, a first capacitor control switch S1, a second capacitor C2, a second capacitor control switch S2 and a control switch S3. The first capacitor C1 is coupled between the input bus 204 and a ground potential GND. The first capacitor control switch S1 is coupled in series with the first capacitor C1 between the input bus 204 and the ground potential GND. The second capacitor control switch S2 is coupled in series with the second capacitor C2 between the input bus 204 and the ground potential GND. The control switch S3 is coupled between a connection node of the first capacitor C1 and the first capacitor control switch S1 and a connection node of the second capacitor C2 and the second capacitor control switch S2. As shown in FIG. 2, when (1) the control switch S3 is turned on and (2) the first capacitor control switch S1 and the second capacitor control switch S2 are turned off, the first capacitor C1 and the second capacitor C2 are coupled in series between the input bus 204 and the ground potential GND. When (1) the control switch S3 is turned off and (2) the first capacitor control switch S1 and the second capacitor control switch S2 are turned on, the first capacitor C1 and the second capacitor C2 are coupled in parallel.

In the embodiment shown in FIG. 2, the energy storage circuit 201 further comprises a control circuit 203, configured to receive the input voltage Vin, and to provide a first control signal GA to control the first capacitor control switch S1 and the second capacitor control switch S2, and a second control signal GB to control the control switch S3.

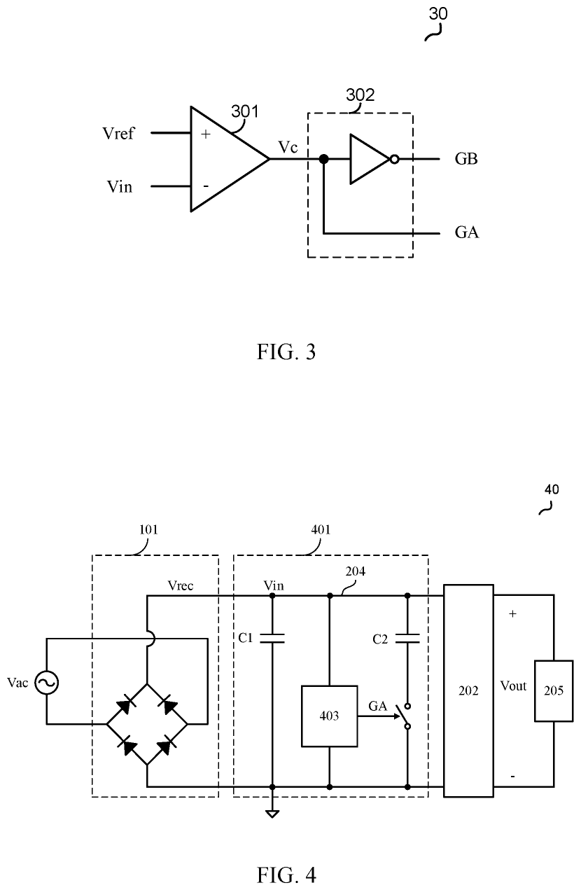

FIG. 3 schematically shows a control circuit 30 in accordance with an embodiment of the present invention. The control circuit 30 could be adopted by the energy storage circuit 201 in FIG. 2 to control the switches S1-S3. As shown in FIG. 3, the control circuit 30 comprises a comparator 301 and a logic circuit 302. The comparator 301 has a first input terminal configured to receive the input voltage Vin, a second input terminal configured to receive a reference voltage Vref, and an output terminal configured to provide a comparison signal Vc based on a comparison result of the input voltage Vin and the reference voltage Vref. The logic circuit 302 has an input terminal configured to receive the comparison signal Vc, a first output terminal configured to provide a first control signal GA to control the first capacitor control switch S1 and the second capacitor control switch S2, and a second output terminal configured to provide a second control signal GB to control the control switch S3, wherein the second control signal GB has an opposite phase with the first control signal GA.

In the example of FIG. 3, the logic circuit 302 comprises an inverter. When the input voltage Vin is lower than the reference voltage Vref, the comparison signal Vc is in a logical high level. After the logic circuit 302, the first control signal GA is logical high and the second control signal GB is logical low. Then the first capacitor control switch S1 and the second capacitor control switch S2 are turned on, and the control switch S3 are turned off. As a result, the first capacitor C1 and the second capacitor C2 are coupled in paralleled between the input bus 204 and the ground potential GND. When the input voltage Vin is higher than the reference voltage Vref, the comparison signal Vc is in a logical low level. After the logic circuit 302, the first control signal GA is logical low and the second control signal GB is logical high. Then the first capacitor control switch S1 and the second capacitor control switch S2 are turned off, and the control switch S3 are turned on. As a result, the first capacitor C1 and the second capacitor C2 are coupled in series between the input bus 204 and the ground potential GND. A value of the reference voltage Vref could be determined by a requirement of detailed application. For example, the value of the reference voltage Vref could be ½ of a peak value of the AC line voltage.

In one embodiment, the comparator 301 comprises a hysteretic comparator having an upper limit with a value of Vref+Vhys1 and a lower limit with a value of Vref-Vhys2, wherein Vhys1+Vhys2 is the hysteresis band of the comparator 301, and wherein the values of Vhys1 and Vhys2 could be the same or be the different, and could be determined by requirements of the application. The comparison signal Vc is in high logical level when the input voltage Vin is lower than the lower limit Vref-Vhys2, and is in low logical level when the input voltage Vin is higher than the upper limit Vref+Vhys1. In this way, the comparison signal Vc avoids flipping when the input voltage Vin is around the reference voltage Vref.

In one embodiment, the hysteresis band Vhys1+Vhys2 is larger than the fluctuating value of the input voltage Vin in a cycle. As known by persons of ordinary skill in the art, the AC line voltage Vac usually has a frequency, like 50-60 Hz. After rectification, the rectified voltage Vrec and the input voltage Vin have a frequency of about 120 Hz. That is to say, the input voltage Vin is varying with a cycle of 1/f, wherein f is the frequency of the rectified voltage Vrec and the input voltage Vin, which is 1/120 second when the switching frequency is 120 Hz. Thus, the input voltage Vin has a peak value and a valley value in each cycle, i.e., in each half cycle of the AC line voltage Vac. The hysteresis band Vhys1+Vhys2 is designed to be larger than an amplitude of the ripple defined by the peak value and the valley value of the input voltage Vin. In this way, the comparison signal Vc avoids flipping with the fluctuations of the input voltage Vin.

As shown in the embodiment of FIG. 2, the DC-DC converter 202 comprises a flyback converter. The flyback converter comprises a transformer T1 and a power switch PM. The transformer T1 has a primary winding Lp and a secondary winding Ls, wherein the primary winding Lp configured to receive the input voltage Vin, and the secondary winding Ls is configured to provide power to a load 205. The power switch PM is coupled between the primary winding Lp and the ground potential GND, wherein the power switch PM is turned on and off by a power control signal PG to transfer power from the primary winding Lp to the secondary winding Ls.

It should be known that other DC-DC converters, like Buck converter, Boost converter, Buck-Boost converter and LLC converters could also be utilized in the power converters provided by the present invention.

In the embodiment of FIG. 2, the rectifier 101 comprises a full bridge rectifier having four diodes coupled as shown in FIG. 2. It should be known that half bridge rectifier could also be utilized to convert the AC line voltage Vac to a DC voltage. Furthermore, the diodes in the rectifier 101 could be replaced by controlled switches.

FIG. 4 schematically shows an AC-DC power converter 40 in accordance with an embodiment of the present invention. The AC-DC power converter 40 comprises a rectifier 101, an energy storage circuit 401 and a DC-DC converter 202. As shown in FIG. 4, the energy storage circuit 401 comprises a first capacitor C1, a second capacitor C2 and a second capacitor control switch S2. The first capacitor C1 is coupled between an input bus 204 and a ground potential GND. The second capacitor control switch S2 is coupled in series with the second capacitor C2 between the input bus 204 and the ground potential GND; wherein the second capacitor control switch S2 is turned on when the input voltage Vin provided by the input bus 204 is lower than a reference voltage Vref to couple the second capacitor C2 in parallel with the first capacitor C1.

In the embodiment shown in FIG. 4, the energy storage circuit 401 further comprises a control circuit 403, configured to receive the input voltage Vin, and to provide a first control signal GA to control the second capacitor control switch S2.

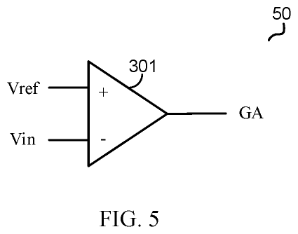

FIG. 5 schematically shows a control circuit 50 in accordance with an embodiment of the present invention. The control circuit 50 could be adopted by the energy storage circuit 401 in FIG. 4 to control the second capacitor control switch S2. As shown in FIG. 3, the control circuit 50 comprises: a comparator 301, having a first input terminal configured to receive the input voltage Vin, a second input terminal configured to receive a reference voltage Vref, and an output terminal configured to provide a comparison signal Vc; wherein the comparison signal Vc is used as the first control signal GA to control the second capacitor control switch S2.

In the example of FIG. 5, the first control signal GA is logical high when the input voltage Vin is lower than the reference voltage Vref. Then the second capacitor control switch S2 is turned on. As a result, the first capacitor C1 and the second capacitor C2 are coupled in paralleled between the input bus 204 and the ground potential GND. When the input voltage Vin is higher than the reference voltage Vref, the first control signal GA is logical low. Then the second capacitor control switch S2 is turned off. As a result, the second capacitor C2 is disconnected.

In the present invention, the energy storage circuits provide larger capacitance, which is C1+C2 when the rectified voltage Vrec and the input voltage Vin are low, and provides smaller capacitance, which may be 1(1/C1+1/C2) or C1 when the rectified voltage Vrec and the input voltage Vin are high.

In one embodiment, the first capacitor C1 has a higher voltage rating as compared with the second capacitor C2. In the embodiment of FIG. 4, the second capacitor C2 is only utilized in low line voltage, so the voltage rating of the second capacitor C2 may be considered only for low line voltage. For examples, the voltage rating of the E-CAP for conventional design may be 400 volts or 450 Volts. For the design with the present invention, the first capacitor C1 may need 400 volts or 450 volts of voltage rating, but only 160 volts to 250 volts of voltage rating is good enough for the second capacitor C2.

Compared with the prior art E-CAP, the first capacitor C1 could have lower capacitance, since the larger capacitance needed for low line voltage could be achieved by the paralleled first capacitor C1 and second capacitor C2. For example, when 100 uF capacitance is needed in prior art E-CAP solution to filter the rectified voltage Vrec in low line voltage condition, the solution provided by the present invention may have the first capacitor C1 of 33 uF and the second capacitor C2 of 68 uF. Thus the total size of the first capacitor C1 and the second capacitor C2 may be half of a prior art 100 uF E-CAP.

With the guidance of the present invention, persons of ordinary skill in the art could choose the voltage ratings and capacitances of the first capacitor C1 and the second capacitor C2 according to the requirement of the application to achieve optimized capacitor size.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. An energy storage circuit configured to filter a rectified voltage provided on an input bus, and to provide an input voltage on the input bus, the energy storage circuit comprising:
a first capacitor, coupled between the input bus and a ground potential;
a second capacitor; and
a second capacitor control switch, coupled in series with the second capacitor between the input bus and the ground potential; wherein
the second capacitor control switch is turned on when the input voltage is lower than a lower limit to couple the second capacitor in parallel with the first capacitor, and the second capacitor control switch is turned off when the input voltage is higher than an upper limit to disconnect the second capacitor from the first capacitor.

2. The energy storage circuit of claim 1, further comprising:
a first capacitor control switch, coupled in series with the first capacitor between the input bus and the ground potential; and
a control switch, coupled between a connection node of the first capacitor and the first capacitor control switch and a connection node of the second capacitor and the second capacitor control switch; wherein
the first capacitor and the second capacitor are coupled in series when: (1) the control switch is turned on; and (2) the first capacitor control switch and the second capacitor control switch are turned off; and wherein
the first capacitor and the second capacitor are coupled in parallel when: (1) the control switch is turned off; and (2) the first capacitor control switch and the second capacitor control switch are turned on.

3. The energy storage circuit of claim 2, wherein the second capacitor control switch is turned on and off synchronously with the first capacitor control switch, and the control switch is turned on and off asynchronously with the first capacitor control switch.

4. The energy storage circuit of claim 1, wherein the second capacitor has a larger capacitance as compared with the first capacitor.

5. The energy storage circuit of claim 1, wherein the first capacitor has a higher voltage rating as compared with the second capacitor.

6. An energy storage circuit configured to filter a rectified voltage provided on an input bus, and to provide an input voltage on the input bus, comprising:
a first capacitor, coupled between the input bus and a ground potential;
a second capacitor; and
a second capacitor control switch, coupled in series with the second capacitor between the input bus and the ground potential; wherein
the second capacitor control switch is turned on when the input voltage is lower than a reference voltage to couple the second capacitor in parallel with the first capacitor.

7. The energy storage circuit of claim 6, further comprising a control circuit, wherein the control circuit comprises:
a comparator, configured to receive the input voltage and the reference voltage, and to provide a comparison signal based on a comparison result of the input voltage and the reference voltage; wherein
the comparison signal is provided to control the second capacitor control switch.

8. The energy storage circuit of claim 6, further comprising:
a first capacitor control switch, coupled in series with the first capacitor between the input bus and the ground potential; and
a control switch, coupled between a connection node of the first capacitor and the first capacitor control switch and a connection node of the second capacitor and the second capacitor control switch; wherein
the first capacitor and the second capacitor are coupled in series when: (1) the control switch is turned on; and (2) the first capacitor control switch and the second capacitor control switch are turned off; and wherein
the first capacitor and the second capacitor are coupled in parallel when: (1) the control switch is turned off; and (2) the first capacitor control switch and the second capacitor control switch are turned on.

9. The energy storage circuit of claim 8, further comprising a control circuit, wherein the control circuit comprises:
a comparator, configured to receive the input voltage and the reference voltage, and to provide a comparison signal based on a comparison result of the input voltage and the reference voltage; and
a logic circuit, configured to receive the comparison signal, and to provide a first control signal to control the first capacitor control switch and the second capacitor control switch, and a second control signal to control the control switch, wherein the second control signal has an opposite phase with the first control signal.

10. The energy storage circuit of claim 6, wherein the second capacitor has a larger capacitance as compared with the first capacitor.

11. The energy storage circuit of claim 6, wherein the first capacitor has a higher voltage rating as compared with the second capacitor.

12. A power converter, comprising:
a first capacitor, coupled between an input bus and a ground potential, wherein the first capacitor is configured to filter a rectified voltage to produce an input voltage on the input bus;
a second capacitor;
a second capacitor control switch, coupled in series with the second capacitor between the input bus and the ground potential, wherein the second capacitor is coupled in parallel with the first capacitor when the input voltage is lower than a lower limit; and
a DC-DC power converter, configured to convert the input voltage to a required voltage level.

13. The power converter of claim 12, further comprising a control circuit, wherein the control circuit comprises:
a comparator, configured to receive the input voltage and the lower limit, and to provide a comparison signal based on a comparison result of the input voltage and the lower limit; wherein
the comparison signal is provided to control the second capacitor control switch.

14. The power converter of claim 12, further comprising a control circuit, wherein the control circuit comprises:
a hysteresis comparator, configured to receive the input voltage, the lower limit and an upper limit, and to provide a comparison signal based on a comparison result of the input voltage, the lower limit and the upper limit; wherein
the comparison signal is provided to control the second capacitor control switch, and wherein the comparison signal turns on the second capacitor control switch when the input voltage is lower than the lower limit, and turns off the second capacitor control switch when the input voltage is higher than the upper limit.

15. The power converter of claim 12, further comprising:
a first capacitor control switch, coupled in series with the first capacitor between the input bus and the ground potential;
a control switch, coupled between a connection node of the first capacitor and the first capacitor control switch and a connection node of the second capacitor and the second capacitor control switch; wherein
the first capacitor and the second capacitor are coupled in series when: (1) the control switch is turned on; and (2) the first capacitor control switch and the second capacitor control switch are turned off; and wherein
the first capacitor and the second capacitor are coupled in parallel when: (1) the control switch is turned off; and (2) the first capacitor control switch and the second capacitor control switch are turned on.

16. The power converter of claim 15, further comprising a control circuit, wherein the control circuit comprises:
a comparator, configured to receive the input voltage and the lower limit, and to provide a comparison signal based on a comparison result of the input voltage and the lower limit; and
a logic circuit, configured to receive the comparison signal, and to provide a first control signal to control the first capacitor control switch and the second capacitor control switch, and a second control signal to control the control switch, wherein the second control signal has an opposite phase with the first control signal.

17. The power converter of claim 15, further comprising a control circuit, wherein the control circuit comprises:
a hysteresis comparator, configured to receive the input voltage, the lower limit and an upper limit, and to provide a comparison signal based on a comparison result of the input voltage, the lower limit and the upper limit; and
a logic circuit, configured to receive the comparison signal, and to provide a first control signal to control the first capacitor control switch and the second capacitor control switch, and a second control signal to control the control switch, wherein the second control signal has an opposite phase with the first control signal.

18. The power converter of claim 12, wherein the second capacitor has a larger capacitance as compared with the first capacitor.

19. The power converter of claim 12, wherein the first capacitor has a higher voltage rating as compared with the second capacitor.

20. The power converter of claim 12, wherein the DC-DC converter comprises a flyback converter.
